(19) United States
(12) Patent Application Publication
(10) Pub. No.: US 2009/0044537 A1
(43) Pub. Date: Feb. 19, 2009

(54) APPARATUS AND METHOD FOR EXTERNALLY LOADED LIQUID FUEL INJECTION FOR LEAN PREVAPORIZED PREMIXED AND DRY LOW NOX COMBUSTOR

(75) Inventors: Gregory Allen Boardman, Greer, SC (US); Johnie Franklin McConnaughhay, Greenville, SC (US)

Correspondence Address: CANTOR COLBURN, LLP, 20 Church Street, 22nd Floor, Hartford, CT, 06103, US

(73) Assignee: GENERAL ELECTRIC COMPANY, Schenectady, NY (US)

(21) Appl. No.: 11/840,521

(22) Filed: Aug. 17, 2007

(51) Int. Cl. F02C 3/00

(52) U.S. Cl. 60/737; 60/740

(57) ABSTRACT

A fuel injector stick for a gas turbine includes: a body of a length, L, the body including an annular shape forming a fuel channel and adapted for insertion into a premixer of the gas turbine; a mounting section for mounting the injector stick to the gas turbine; and a nozzle for injecting fuel into the premixer of the gas turbine. A gas turbine combustor and a method for changing fuel injector sticks are provided.

### BACKGROUND OF THE INVENTION

1. Field of the Invention

The invention disclosed herein relates to gas turbine combustors, and in particular to techniques for atomizing fuel.

2. Description of the Related Art

Contemporary heavy-duty industrial dry-low-NOₓ (DLN) gas turbine combustors using lean-prevaporized-premixed (LPP) fuel nozzle designs typically employ a multiplicity of atomizer fuel injectors in a nozzle premixer to disperse fuel into most of the premixer air and thus to premix the fuel and air prior to the combustion zone. This is the case for both annular and can-annular combustor designs. In most instances, fuel injection atomizers are located on an outer wall of the premixer, on axial or radial swirler vanes, on a centerbody (or hub) of each nozzle, or on the backplate of a radial swirler.

Similar features are included in most of these designs. For example, in just about all these designs, an internal fuel gallery is included as well as permanent integration of the liquid fuel passages and atomizer injectors with part or the entire nozzle. Quite often, insulation or active internal cooling is added to a design to combat or ameliorate internal coking (when standard, non-treated liquid hydrocarbon fuels are used); however, the LPP nozzle design usually gets more complicated and expensive as a tradeoff.

More specifically, DLN and LPP nozzle designs typically incorporate a multi-point atomizer injection scheme to uniformly disperse the fuel into and mix it with the bulk of the premixer air. This design approach generally involves using one or more annular liquid fuel galleries to distribute the fuel as evenly as possible to each of the atomizers in the premixer. However, there are disadvantages associated with this approach: first, an internal complex flow network/geometry that is subjected to the compressor discharge temperature and is, thus, prone to coking, and, second, the costly downtime associated with frequent, labor intensive nozzle cleaning and refurbishment.

As the liquid hydrocarbon (HC) fuel flows in the fuel nozzle, it is gradually heated, and at some point the fuel may reach a temperature where thermal breakdown occurs (which is about 290° F. for No. 2 diesel). Carbon will begin to deposit on the wetted fuel-circuit surfaces. This carbon can build up in time (like plaque in an artery) and eventually clog all or part of the nozzle's liquid fuel circuit(s), which results in poor fuel distribution in the nozzle and possibly the engine's combustion system as a whole.

Generally, insulation or active cooling is used to combat or ameliorate coking problems. Unfortunately, the LPP nozzle design usually becomes more complicated and expensive as a result.

Further, once the liquid fuel circuits of one or more LPP nozzles foul (or coke) in an engine set, which is inevitable, it typically necessitates unit down time and a costly, labor intensive cleaning/refurbishment process for the suspect nozzles. Since, the atomizers and fuel gallery are part of the internal geometry of each nozzle's premixer, quick, convenient field maintenance is typically not an option.

If, for example, there were 108 LPP nozzles in a F-Class engine, then most likely there would be 108 fuel galleries, each distributing fuel to multiple atomizers within the premixer and each having the potential of fouling at some point. Having at least one, two or a few fouled nozzles may throw the combustion fuel system out of balance to the point where emissions or the combustor-exit exhaust pattern factor becomes unacceptable.

What are needed are cost effective and improved fuel mixing technologies for a gas turbine combustor, such as those disclosed herein.

### BRIEF DESCRIPTION OF THE INVENTION

Disclosed is an embodiment of a fuel injector stick for a gas turbine combustor, the fuel injector stick including: a body of a length, L, the body including an annular shape forming a fuel channel and adapted for insertion into a premixer of the gas turbine combustor; a mounting section for mounting the injector stick to the gas turbine combustor; and a nozzle for injecting fuel into the premixer of the gas turbine combustor.

Also disclosed is an embodiment of a gas turbine combustor including: a plurality of fuel injector sticks disposed therein, each of the plurality including a body of a length, L, the body including an annular shape forming a fuel channel and adapted for insertion into a premixer of the gas turbine combustor; a mounting section for mounting the fuel injector stick; and a nozzle for injecting fuel into the premixer of the gas turbine combustor.

An embodiment of a method for changing fuel in a can-annular gas turbine combustor is disclosed and includes: selecting the fuel for the gas turbine combustor, removing at least one fuel injector stick inserted into a premixer of the gas turbine combustor, each stick including a body of a length, L, of an annular shape forming a fuel channel, a mounting section for mounting the injector stick to an endcover of the gas turbine combustor, and a nozzle for injecting fuel into the premixer of the gas turbine combustor; and replacing the at least one fuel injector stick with another at least one fuel injector stick designed for dispensing the selected fuel.

### BRIEF DESCRIPTION OF THE DRAWINGS

Referring now to the drawings wherein like elements are numbered alike in the several Figures, wherein:

FIG. 1 provides a cutaway view of an injector stick;

FIG. 2 provides an aft view of a combustor endcover including an array of the injector stick;

FIG. 3 provides an isometric view of the combustor endcover with injector sticks mounted therein, where certain ones of the injector sticks are coupled to a distributor; and

FIG. 4 provides a cutaway view of a combustor assembly according to the teachings herein.

### DETAILED DESCRIPTION OF THE INVENTION

Disclosed is a fuel dispensing system for a gas turbine combustor. In some embodiments, the gas turbine combustor that incorporates the fuel dispensing system is a can-annular gas turbine combustor with a liquid-fuel dry-low-NOₓ (DLN), lean-prevaporized-premixed (LPP) radial nozzle design. The fuel dispensing system includes a plurality of externally loaded and fed atomizer liquid fuel injection sticks (also referred to as “injector sticks,” “fuel injection sticks” or “injector sticks” and by similar terms) for main liquid fuel injection into a radial-inflow swirler (also referred to as a “premixer”). In some embodiments, the plurality of injection sticks is disposed as a circular array which is generally concentric with an axis of rotation for the gas turbine combustor. Unlike some liquid injectors of the prior art, the injection sticks do not require air assist for atomization. In various embodiments, the injections sticks, are shorter, smaller in diameter, are provided as a plurality for each nozzle, and thread into place, (instead of being bolted).

The teachings herein provide a variety of advantages over the prior art. Some non-limiting examples are provided. The teachings provide for efficient dispersion of liquid fuel into a radial-inflow premixer using multipoint atomization and injection by use of the plurality of injection sticks (which may also be referred to as “fuel injectors” and by other similar terms). The design is such that supplemental atomizer air is not required. The teachings also provide for simplified assembly and maintenance as well as reduced risk of internal fuel leakage. Further, improved durability and performance is realized through anti-coking features. Notably, an assortment of liquid fuels may be used. That is, each of the injection sticks may be modified to provide for a different flow number or design type (e.g., jet swirl, fan, plain jet, effervescent, etc.), thus, allowing the same radial-inflow premixer design to handle an assortment of different liquid fuels.

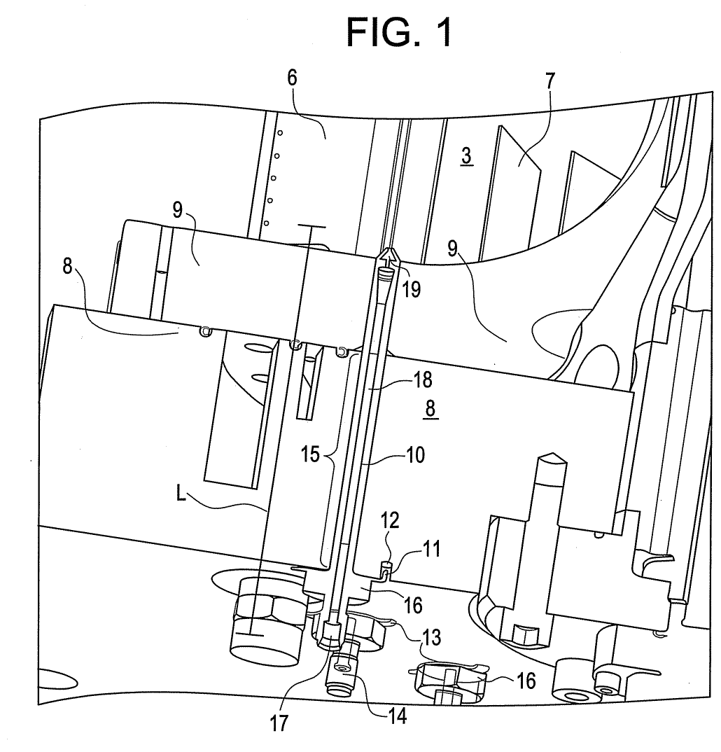

Referring now to FIG. 1, there is shown a cutaway view of an exemplary embodiment of an injection stick 10. The injection stick 10 is shown disposed within an endcover 8 and extending through a backplate 9 of a swirler 6 into a premixer 3. The injection stick 10 is shown as protruding from a concomitant radial slot of the swirler 6 into the premixer 3. Included in FIG. 1, for reference is a radial vane 7 of the swirler 6. The injection stick 10 is fabricated from materials as are known in the art for use in fuel nozzles.

Each injection stick 10 includes a length, L. The length, L, is generally selected to penetrate the endcover 8 and the backplate 9 and provide sufficient penetration into a swirling area to meet design requirements. The injection stick 10 includes a body that is of an annular shape along the length, L, thus forming a fuel channel 18.

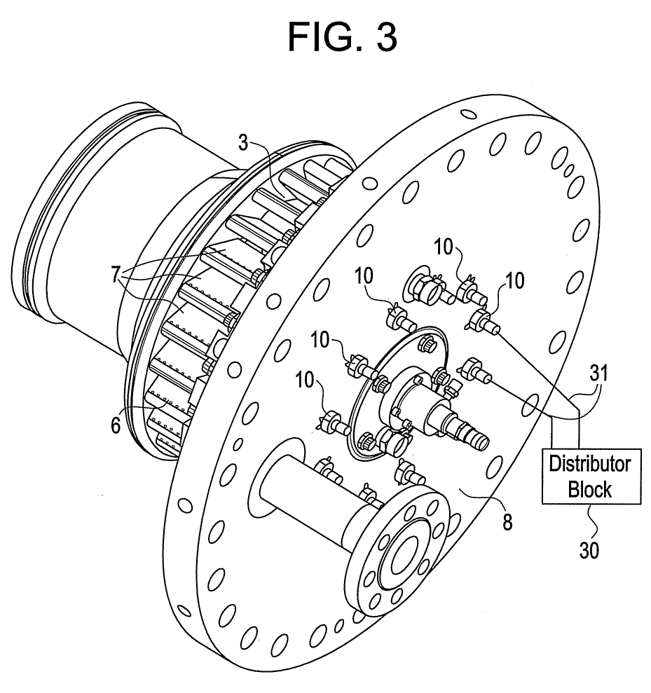

The injection stick 10 includes a mounting section 14 for mounting of a fuel supply line (shown if FIG. 3 as item 31) used to supply the fuel channel 18 through a fuel feed 17. The mounting section 14 provides for secure mounting of the supply line, and may include a variety of connector technologies for the secure mounting.

In the embodiment depicted, the injection stick 10 includes a threaded section 15. The threaded section 15 threads into the endcover 8. In some embodiments, the threaded section 15 extends into the backplate 9 of the swirler 6. In some embodiments, the injection stick 10 includes a lock nut 16 for securing the injection stick 10 in place.

An assembled injection stick 10 generally includes a key 11 that fits snugly into a keyway 12 of the endcover 8. In some embodiments, the key 11 is included as a part of a washer 13 which includes a flat portion on an inner circumference. The flat portion is included in the washer 13 as a mate to a flat portion on an external surface of the injection stick 10, and provides for locking the injection stick 10 into place. That is, when installed, the washer 13 with the key 11 fits snugly about an outer circumference of the injection stick 10, thus preventing turning of injection stick 10. Accordingly, system vibration generally does not perturb an installation of the injection stick 10.

The injection stick 10 further includes a nozzle 19. The nozzle 19 protrudes into the premixer 3. In some embodiments, the nozzle of the injection stick 10 protrudes about ⅛ of an inch (about 3.2 millimeters) into a respective swirler slot. The nozzle 19 may be a detachable apparatus or may be fabricated as a part of the injection stick 10. Accordingly, differing fuel types may be accommodated by changing at least one of the injection stick(s) 10 and respective nozzles 19.

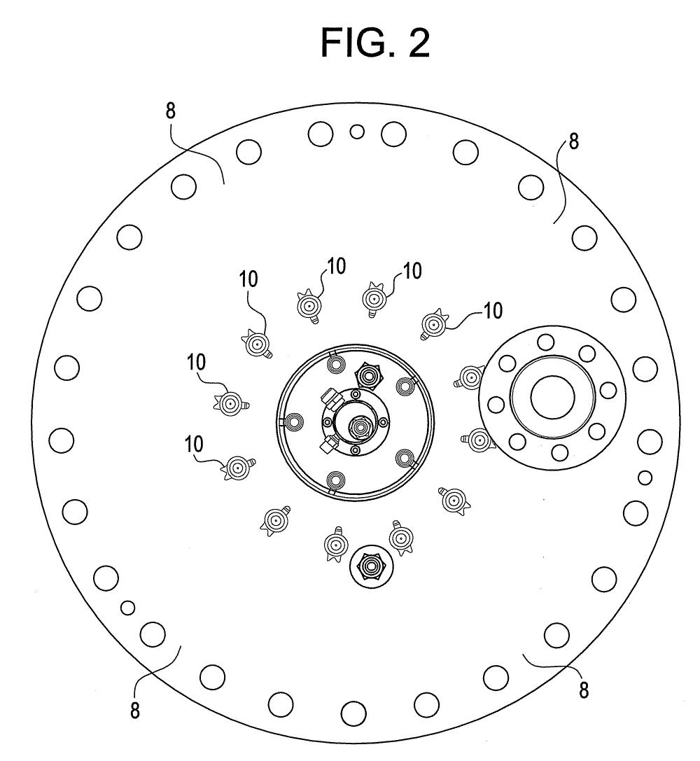

Referring now to FIG. 2, an end view is provided showing a plurality of the injection sticks 10 disposed in the endcover 8. Generally, the plurality of the injection sticks 10 are evenly distributed such that homogenous mixing within the premixer 3 occurs quickly during operation.

Referring now to FIG. 3, a side view is provided showing the plurality of the injection sticks 10 evenly distributed about the endcover 8. The plurality is distributed such that efficient mixing occurs within the swirler 6 of the premixer 3. Also shown is a distributor block 30 that provides a fuel supply to each of the injection sticks 10 via a plurality of supply lines 31.

In some embodiments, each injection stick 10 is connected to a single external distributor block 30 using a tube (flex or hard) and appropriate fittings as the supply line 31. In FIG. 3, two of twelve injection sticks 10 are coupled to the distributor block 30. In some embodiments, the distributor block 30 is located and fixed to the endcover 8 via a bracket or rod connection. In some embodiments, two or more distributor blocks 30 are used. For example, two or more distributor blocks 30 may be used where staging the injection sticks 10 (i.e., fuel injectors) for meeting turndown requirements is desired.

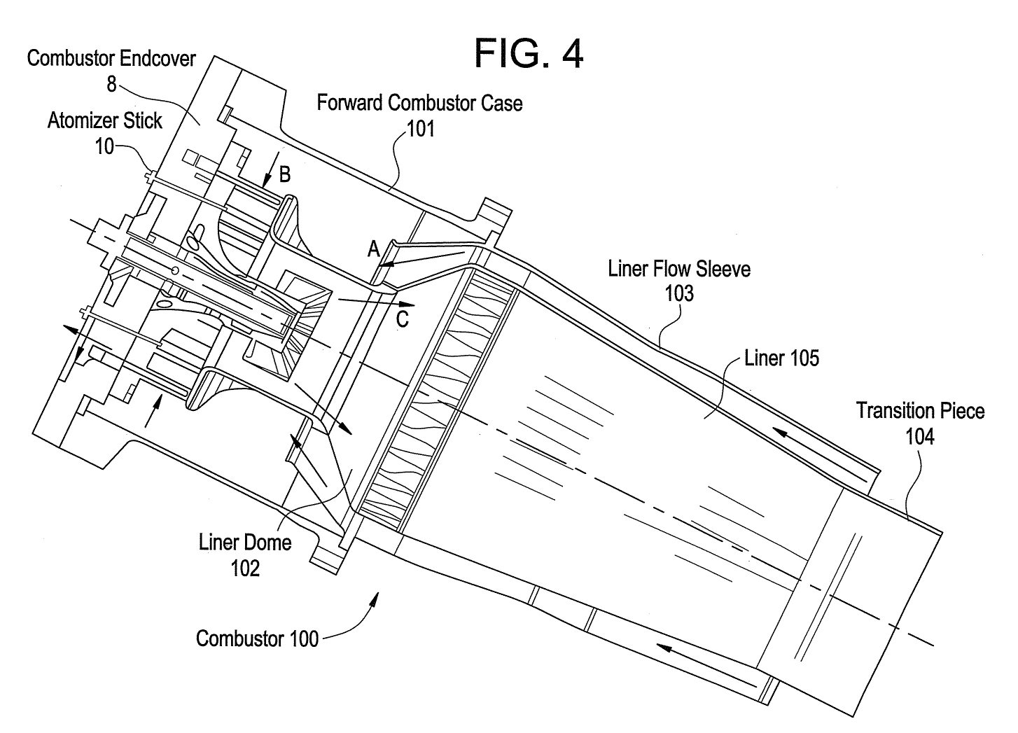

Further, with reference to FIG. 4, there is shown an exemplary embodiment of a combustor 100 making use of the teachings herein. The combustor 100 depicted includes the combustor endcover 8 and the plurality of injection sticks 10 disposed therein. The endcover 8 is coupled to the forward combustor case 101, which surrounds the liner dome 102. The liner dome 102 is disposed at an internal end of the liner, the liner plugging into a transition piece 104. The liner is disposed within a liner flow sleeve 103. The transition piece may be coupled to an exhaust or other feature (not shown).

In the example depicted, combustion air generally flows in between the liner 105 and the liner flow sleeve 103, along the course depicted as “A.” The combustion air enters the swirler 6, as depicted by notation “B,” and is mixed with fuel delivered by the plurality of injection sticks 10. Following combustion, combustion by-products exit from the combustor via the liner 105.

Now, with an understanding of the injection stick 10 (also referred to as a “fuel injector” and by other similar terms), as well as a combustor that makes use of the teachings herein, certain advantages and other aspects are discussed.

First, the design allows for multiple individual main fuel injection sticks 10 to be used in a radial-inflow LPP premixer. The design effectively atomizes and disperses fuel without requiring additional, high-pressure atomizer air, and is therefore more efficient than prior art designs. The embodiment depicted herein uses twelve injectors, (one injector for every other radial swirler slot). However, more or fewer fuel injectors could be used, depending on requirements for the combustor.

Second, the design allows individual fuel injectors to be removed or replaced from outside the engine without having to disassemble the combustor or casings. This provides for greatly improved maintainability and serviceability. For example, the injection sticks 10 may be placed by just threading them into the endcover 8, in a process that is similar to installation of sparkplugs for an internal combustion engine.

Third, because of the directness of the design and the lack of internal, integrated liquid flow passages, the possibility of an undetected leak of internal liquid fuel is virtually eliminated. Essentially all of the distribution tubes and fittings may be maintained outside of the endcover 8.

Fourth, as the main liquid fuel distributor block 30 is external to the combustor endcover 8, heating of the main liquid fuel distribution circuits and therefore coking is greatly reduced. Also, the design allows for multipoint liquid fuel injection into the radial-inflow premixer without the possibility of sluggish or trapped fuel in an internal fuel gallery or flow separation around internal corners or sudden expansions. All of which are known contributors to fuel circuit coking in LPP nozzle designs.

In addition, since one set of atomizers can be easily replaced with a new set, the design provides for rapid change over to accommodate a variety of fuels. This feature makes it possible for the same radial inflow premixer 3 to be used in a wide assortment of liquid-fuel applications, simply by use of different sets of injection sticks 10.

The teachings herein may be used with nearly any can-annular heavy duty gas turbine combustor that uses one or multiple radial-inflow DLN nozzles.

A can-annular gas turbine combustor according to the teachings herein uses a liquid-fuel, dry-low-NOx (DLN), lean-prevaporized-premixed (LPP) radial nozzle design that incorporates a bolt-circle array of externally loaded and fed injection sticks for main liquid fuel injection.

This design's purpose is multifaceted: (1) effective and efficient dispersion of liquid fuel into a radial-inflow premixer using multipoint atomization and injection while not requiring additional supplemental atomizer air, (2) ease of assembly and maintenance, (3) reduced risk of internal fuel leakage, (4) improved durability and performance through anti-coking measures, and (5) to provide increased liquid-fuel flexibility by allowing the atomizers to be easily replaced with a different flow number or design type (e.g., jet swirl, fan, plain jet, effervescent, etc.), thus, allowing the same radial-inflow premixer design to handle an assortment of different liquid fuels.

Improved capability and fuel flexibility is provided. Dry Low NOx (DLN) on oil and other liquid fuels without requiring an atomizer air compressor. The liquid fuel injection hardware can be removed or replaced without having to disassemble the combustor or casings. Reduced risk is realized. That is, design elements provided herein eliminate the chance of internal liquid fuel leakage. Further, improved operability and durability is achieved. That is, aspects of the design greatly reduce the chance of internal coking; thus, decreasing the frequency of required unit downtime for cleaning and servicing. The design simplicity provides improved serviceability. For example, the liquid fuel injection hardware can be removed or replaced without having to disassemble the combustor or casings. Chemical treatment or conditioning of the liquid fuel is not required as the fuel is not preheated in the manner of the prior art.

The atomizer fuel injector sticks 10 are positioned around the premixer annulus of each DLN combustor nozzle. The atomizer on each stick pokes “slightly” (for example, about ⅛″) beyond the nozzles backplate into the premix annulus. Fuel dispersion, vaporization, and mixing occur in the premix annulus while burning occurs in the respective combustor can or liner. In the embodiment described herein, there is only one DLN nozzle per combustor. However, in other embodiments more DLN nozzles may be used. The combustor cans (usually canted) are spaced evenly around the engine's centerline. For example, in one embodiment, referred to as a “9FB engine” there are 18 such cans.

The fuel distribution system uses external tubing, piping, channels, etc. to evenly distribute the fuel to all of the active atomizer fuel injectors 10 in the DLN nozzle premixer (among other things, to provide lower emissions). The liquid fuel is kept cooler by keeping the distribution circuits external to the endcover (thus, less maintenance is required). Also, the external design allows the individual atomizer fuel injection sticks to be removed without needing to one of disassemble and remove the combustor cases or endcover (that is, better serviceability and less downtime is achieved over the prior art).

While the invention has been described with reference to an exemplary embodiment, it will be understood that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A fuel injector stick for a gas turbine combustor, the fuel injector stick comprising:
a body of a length, L, the body comprising an annular shape forming a fuel channel and adapted for insertion into a premixer of the gas turbine;
a mounting section for mounting the injector stick to the gas turbine combustor; and
a nozzle for injecting fuel into the premixer of the gas turbine combustor.

2. The fuel injector stick as in claim 1, wherein an outer portion of the body comprises threads.

3. The fuel injector stick as in claim 1, wherein an external surface of the body comprises a flat portion for mating with a washer comprising a flat portion on an inner circumference.

4. The fuel injector stick as in claim 3, wherein the washer comprises a key for fitting into a keyway.

5. The fuel injector stick as in claim 1, wherein the fuel injector stick comprises a design for delivering a type of fuel.

6. The fuel injector stick as in claim 1, wherein the nozzle of the fuel injector stick is interchangeable.

7. The fuel injector stick as in claim 1, wherein the mounting section is adapted for mounting a fuel supply line.

8. A gas turbine combustor comprising:
a plurality of fuel injector sticks disposed therein, each of the plurality comprising a body of a length, L, the body comprising an annular shape forming a fuel channel and adapted for insertion into a premixer of the gas turbine combustor; a mounting section for mounting the fuel injector stick; and a nozzle for injecting fuel into the premixer of the gas turbine combustor.

9. The gas turbine combustor as in claim 8, wherein the plurality of fuel injector sticks are distributed concentrically about an axis of rotation for a premix nozzle.

10. The gas turbine combustor as in claim 8, comprising a design for at least one of a dry-low-NOₓ design and a lean prevaporized premixed design.

11. The gas turbine combustor as in claim 8, wherein the gas turbine combustor comprises a can-annular gas turbine combustor.

12. The gas turbine combustor as in claim 8, wherein at least one of the fuel injector sticks is disposed through an endcover of the gas turbine combustor.

13. The gas turbine combustor as in claim 8, wherein an endcover comprises a plurality of keyways, each keyway adapted for securing one of the fuel injector sticks into the endcover.

14. The gas turbine combustor as in claim 8, wherein a design for the plurality of fuel injector sticks provides for homogeneous mixing, which occurs quickly during operation.

15. The gas turbine combustor as in claim 8, wherein a fuel supply is external to the gas turbine combustor.

16. The gas turbine combustor as in claim 8, wherein the fuel injector stick comprises a design type that is one of a pressure swirl, jet swirl, a fan, a plain jet or an effervescent atomizer.

17. The gas turbine combustor as in claim 8, wherein at least one of the fuel injector sticks comprises threads for securing the body into the gas turbine.

18. The gas turbine combustor as in claim 8, wherein at least one of an endcover and the premixer comprises threads for retaining at least one of the fuel injector sticks.

19. A method for changing fuel in a can-annular gas turbine combustor, the method comprising:
selecting the fuel for the gas turbine combustor,
removing at least one fuel injector stick inserted into a premixer of the gas turbine, each stick comprising a body of a length, L, of an annular shape forming a fuel channel, a mounting section for mounting the injector stick to an endcover of the gas turbine combustor, and a nozzle for injecting fuel into the premixer of the gas turbine combustor; and
replacing the at least one fuel injector stick with another at least one fuel injector stick designed for dispensing the selected fuel.
